(19) United States
(12) Patent Application Publication
(10) Pub. No.: US 2017/0030427 A1
(43) Pub. Date: Feb. 2, 2017

(54) SHOCK ABSORBER DAMPER

(71) Applicant: BELLAMYS RACING & ENGINEERING WORKS LIMITED, Southampton, Hampshire (GB)

(72) Inventor: Joe Hunter, Southampton (GB)

(21) Appl. No.: 15/106,740

(22) PCT Filed: Dec. 19, 2014
(86) PCT No.: PCT/GB2014/053805

§ 371 Date: Jun. 20, 2016

(30) Foreign Application Priority Data
Dec. 20, 2013 (GB) 1322773.1
Sep. 9, 2014 (GB) 1415914.9

(51) Int. Cl. F16F 9/06; F16F 9/34; F16F 9/44; F16F 9/36

(52) U.S. Cl. CPC F16F 9/062; F16F 9/36; F16F 9/34; F16F 9/44; F16F 9/063; B60G 15/065

(57) ABSTRACT

A shock absorber damper (1) comprising a cylinder housing (2) and a piston (3b), the piston comprises a piston damping fluid sub-chamber (10) and a gas sub-chamber (5), and said sub-chambers separated by a moveable divider (6), and the damper comprises a tube (12) which allows displacement of damping fluid therethrough, and the tube comprises a first port (12a) and a second port (12b) which are spaced apart from each other along the length of the tube, and the damper further comprises a damper valve (14), and the damper valve provided between a first sub-chamber (15a) and a second sub-chamber (15b), and wherein, the tube arranged to allow flow of fluid between one of the sub-chambers and the piston damping fluid chamber.

### TECHNICAL FIELD

The present invention relates generally to shock absorber dampers.

### BACKGROUND

Known shock absorbers are such that when a vehicle (to which the absorber is mounted) traverses over terrain or during vehicle maneuvers any body/axle displacement results in the piston rod, oil cylinder piston and damping valve arrangement of the damper to move axially within the damping fluid chamber. This axial movement causes damping fluid to flow through the damping valve arrangement, ie from one sub-chamber within the damping fluid chamber to the other, allowing damping forces to be generated by the flowrate of the damping fluid passing through the damping valve arrangement. The damping fluid flowrate is a product of the working area of the oil cylinder piston and the axial velocity of the oil cylinder piston and damping valve arrangement within the damping fluid chamber.

As the two sides of the oil cylinder piston and damping valve arrangement have different working areas, due to one side being connected to a piston rod, the damping fluid flowrates are different during damper compression and extension for the same axial velocity. To provide the same damping forces for specific axial velocities, the conventional damping valve arrangement has different shim stacks each side of the oil cylinder piston.

As the damper transitions from fully extended to fully compressed, the piston rod enters the damping fluid chamber and displaces an equivalent volume of damping fluid. This variance in the damping fluid chamber volume during operation may be resolved by way of a gas chamber and gas piston to separate the gas chamber from the damping fluid chamber allowing the displaced damping fluid to act on and displace the gas piston which compresses/expands the gas within the gas chamber. The gas chamber is charged to the minimum pressure to stop the damping fluid cavitating.

To overcome the issue of the unequal areas of each side of the oil cylinder piston has resulted in the development of the “through rod” damper. With this type of damper the piston rod extends through the oil cylinder piston and fluid valve arrangement to provide the same area to both sides of the oil cylinder piston, allowing the same shim stacks to be used for damper compression and extension.

However, extending the piston rod outside the damping fluid chamber commonly causes installation difficulties, and as a result, this style of damper is not generally selected for use in vehicle suspension systems, but more for auxiliary use such as motorbike steering dampers. This design can also accommodate an auxiliary gas chamber and a gas chamber piston that separates the gas chamber from the damping fluid chamber with the gas chamber charged to the minimum pressure in order to stop the damping fluid cavitating during damper extension.

We have devised an improved shock absorber damper.

### SUMMARY

According to the invention there is provided a shock absorber damper comprising a cylinder housing and a piston, the piston may comprise a piston damping fluid sub-chamber and a gas sub-chamber, and said sub-chambers separated by a moveable divider, and the damper may comprise a tube which allows displacement of damping fluid therethrough, and the tube may comprise a first port and a second port which are spaced apart from each other along the length of the tube, and the damper may further comprise a damper valve, and the damper valve provided between a first sub-chamber and a second sub-chamber, and wherein, the tube arranged to allow flow of fluid between one of the sub-chambers and the piston damping fluid chamber.

The tube is preferably arranged to allow displacement of damping fluid between damping fluid chambers.

The piston may comprise an aperture through which the tube is arranged to pass.

The damper may comprise a seal which seals the tube within the aperture, whilst allowing relative movement between the tube and the piston.

The damper valve may comprise two uni-directional valve assemblies, each of which allows fluid flow in a respective direction opposite to the direction of flow of the other. The valve preferably divides a portion of the cylinder space.

Preferably, the piston may be arranged to receive the tube such that the piston is arranged for reciprocable movement relative to the piston damping fluid chamber.

The tube may be fixed to the damper valve assembly, or to the cylinder housing.

The damper may comprise a piston damping fluid chamber and a cylinder space damping fluid chamber, which cylinder space chamber comprises the first and second sub-chambers.

Preferably, the tube may be arranged to allow movement of damping fluid between the piston damping fluid chamber and the cylinder space damping fluid chamber.

The tube may comprise an open distal end which is arranged to be located within the piston damping fluid chamber.

The tube may be provided in a fixed position relationship relative to the cylinder space.

The tube may be fixedly attached to the piston and slidably mounted by the damper valve.

The piston damping fluid chamber may be provided as a space within the piston.

Preferably, a working surface area presented to and acting on damping fluid in a sub-chamber is substantially the same as the working surface area presented to fluid in the piston chamber by a surface which faces in the direction of a compression movement.

Preferably the damping fluid flow rate through the damping valve (assembly) is substantially the same through the damping valve assembly during extension and extension, ie in both directions of flow of the damping fluid.

One of the sub-chambers may be arranged adjacent to the working surface (eg the foremost end) of the piston. The said sub-chamber may be the other aforementioned sub-chamber (ie not the sub-chamber which is in communication with the tube).

The tube may extend substantially centrally of the longitudinal extent of the cylinder space.

A gas chamber may be provided incorporated with the piston. The gas chamber may be separated from the piston damping fluid chamber by a movable barrier located within the piston.

The tube may be fixedly attached to the piston and movable relative to the damper valve arrangement.

An embodiment of the invention may be viewed as incorporating a damping fluid sub-chamber within a piston and incorporating a damping tube within the damping fluid chamber such that it connects the damping fluid chamber's compression flow sub-chamber and the piston chamber such that it enables the damping fluid flow through the damping valve assembly, providing substantially the same flowrate through the damping valve arrangement during damper compression and extension, and the damper incorporates a gas chamber and gas chamber piston within the piston rod's damping fluid chamber and preferably the working areas of the cylinder piston and the gas cylinder piston are substantially the same (within ±5%), and wherein the gas chamber utilises pressure to supplement the coil spring.

The damper may further comprise any feature described in detailed description below, or shown in the appended drawings.

### BRIEF DESCRIPTION OF THE DRAWINGS

Various embodiments of the invention will now be described, by way of example only, with reference to the following drawings in which:

FIG. 1 is a cross-sectional view of a shock absorber damper, and

FIG. 2 is a cross-sectional view of a second embodiment of a shock absorber damper,

FIG. 3 is a cross-sectional view of a third embodiment of the invention,

FIGS. 4a and 4b are cross-sectional views of damping fluid adjusters,

FIG. 5 is a cross-sectional view of a forth embodiment of the invention,

FIG. 6 is a cross-sectional view of a fifth embodiment of the invention,

FIG. 7 is a cross-sectional view of a sixth embodiment of the invention,

FIG. 8 is a cross-sectional view of a seventh embodiment of the invention,

FIG. 9 is a cross-sectional view of an eight embodiment of the invention,

FIG. 10 is a cross-sectional view of a ninth embodiment of the invention,

FIG. 11 is a cross-sectional view of a tenth embodiment of the invention,

FIGS. 12 to 16 are spring characteristic graphs of different damper types.

FIG. 17 is a cross-sectioned view of an eleventh embodiment, and

FIG. 18 is a cross-sectional view of a twelfth embodiment.

### DETAILED DESCRIPTION

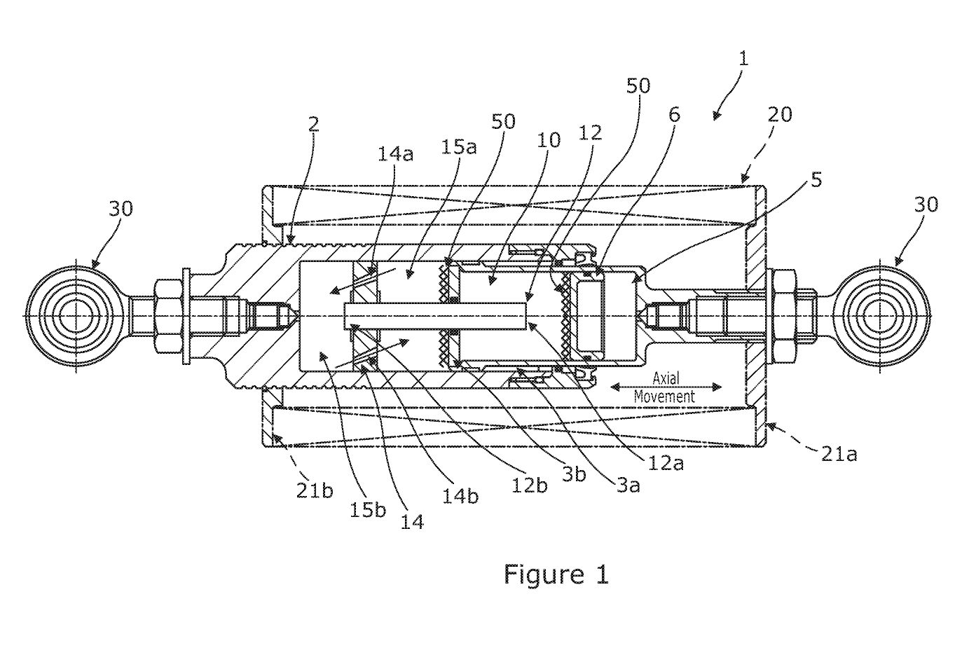

Reference is made initially to FIG. 1 which shows a shock absorber damper 1 for installation as part of a vehicle's suspension system. As will be described below, the damper includes a damper tube which allows substantially the same working surface areas for both compression and extension.

The damper 1 comprises a cylinder body 2 and a piston assembly comprising a piston rod 3a and a piston 3b, with the piston assembly arranged for reciprocable longitudinal movement in the cylinder space. Within a space in the piston assembly there is provided a gas chamber 5 which is bounded at an end thereof by a gas chamber piston 6 which is movable within the piston space, such that it is translationally displaceable within the space in response to differential pressure between the pressure in the gas sub-chamber and that in the damping fluid sub-chamber. The gas chamber piston 6 maintains a gas contained in the chamber in a compressed condition. The piston may be described as a divider or chamber separator. An alternative to the piston is a diaphragm.

The remainder of the space in the piston space constitutes a piston damping fluid sub-chamber 10 and the gas chamber piston 6 serves also to separate the gas from the damping fluid (which may comprise oil).

A foremost end of the piston 3b is provided with an aperture which receives a hollow damper tube 12. A seal is provided radially inwardly of the aperture, but which nevertheless allows the seal to move axially along the tube (in expansion and compression).

Adjacent to the piston 3b, and within the cylinder space of the cylinder body, there is provided a first damping fluid cylinder sub-chamber 15a which contains damping fluid. Also within the cylinder space of the cylinder body there is provided a second damping fluid cylinder sub-chamber 15b. The two sub-chambers are in controlled fluidic communication by way of a damping valve arrangement 14 which comprises throughways 14a and 14b, to allow conveyance of damping fluid in compression and expansion respectively. The damping valve arrangement is provided with shim sets which provide a valving functionality to the flow of the damping fluid.

The damper 1 further comprises a damper tube 12 of which one distal end is attached fixedly to the damping valve arrangement, and extends longitudinally and centrally of the cylinder space. The opposite distal end of the damper tube 12 is open and extends into the piston damping fluid chamber 10. At that end of the damper tube 12 which is fitted to the damping valve 14, said tube is provided with an open end 12b which allows ingress and egress of damping fluid between the sub-chamber 15b and the chamber 10, and the tube 12 having an open end 12a which extends into the chamber. The valve 14 allows damping fluid to flow between sub-chambers 15a and 15b.

The damper 1 further comprises two end plates/flanges 21a and 21b which serve to contain and locate a coil spring 20. The eyed attachment points 30 are connected to the cylinder housing 2 and the piston 3a respectively and allow the damper to be attached to a vehicle to which it is to be installed.

The damper 1 is such that when the vehicle traverses over uneven terrain, or during vehicle maneuvers, any body/axle displacement results in the piston assembly (ie the piston rod and the piston chamber) to move axially within the damping fluid chamber. During damper compression, the axial movement of the piston causes damping fluid to flow through the damping valve arrangement, through the damping tube and into the sub-chamber within the piston rod. During damper extension, the axial movement of the piston causes damping fluid to flow from the piston chamber 10 through the damping tube, through the damping valve arrangement and into the sub-chamber 15a within the cylinder space.

As the damper transitions from fully extended to fully compressed the piston enters the damping fluid chamber and displaces an equivalent volume of damping fluid (the volume of piston's damping fluid sub-chamber wall). This variance in the damping fluid can be resolved by incorporating a gas chamber and a gas piston to separate the gas chamber from the damping fluid chamber.

The damper's damping fluid flowrate is a product of the working area of the oil cylinder piston and its axial velocity within the damping fluid chamber. As the gas chamber is charged to the minimum pressure to stop the damping fluid cavitating, the working face of the oil cylinder piston remains constant, allowing the same damping fluid flowrate during damper compression and extension. Thus permitting the same shim stacks to be used on both sides of the damping valve arrangement.

The working areas, denoted as 50, of the oil cylinder piston and the gas piston are the same (to within ±5%). This permits the axial displacement of the gas chamber piston during compression and extension to be the same as the axial displacement of the damper, resulting in a compact design similar to a conventional damper, thus enabling the novel damper to be a direct replacement to the conventional damper.

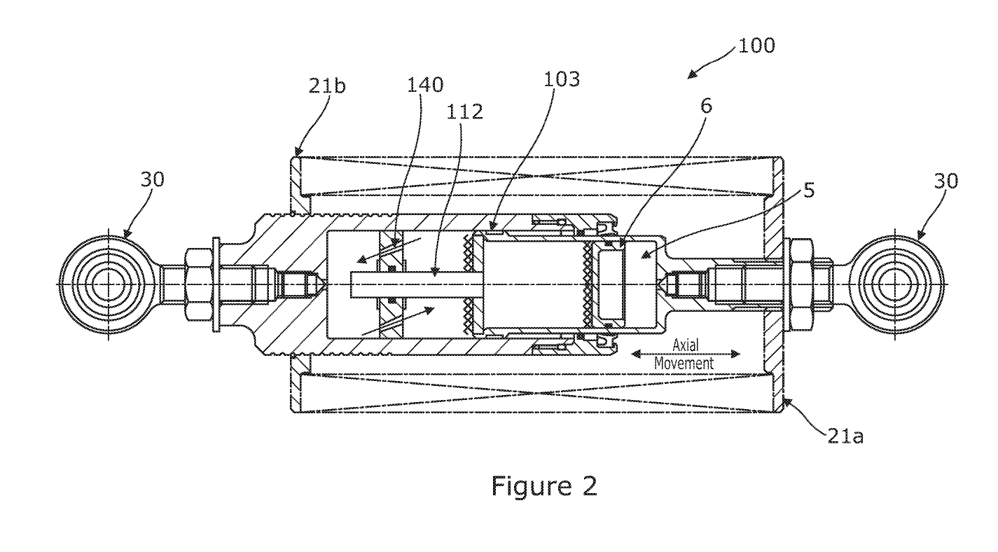

In FIG. 2, a second embodiment of a damper 100 is shown in which the damping valve arrangement 140 is also fixed to the inner surface of the cylinder space, however attached to the foremost end of the piston assembly 103, a damping tube 112 is fixedly provided. In the damper 100, with the tube 112 fixed to the piston, as the piston moves back and forth, it slides in and out of the central aperture of the damping valve arrangement 140. The damper 100 is an alternative embodiment to that of FIG. 1. Like reference numerals are used to denote the same or substantially the same features.

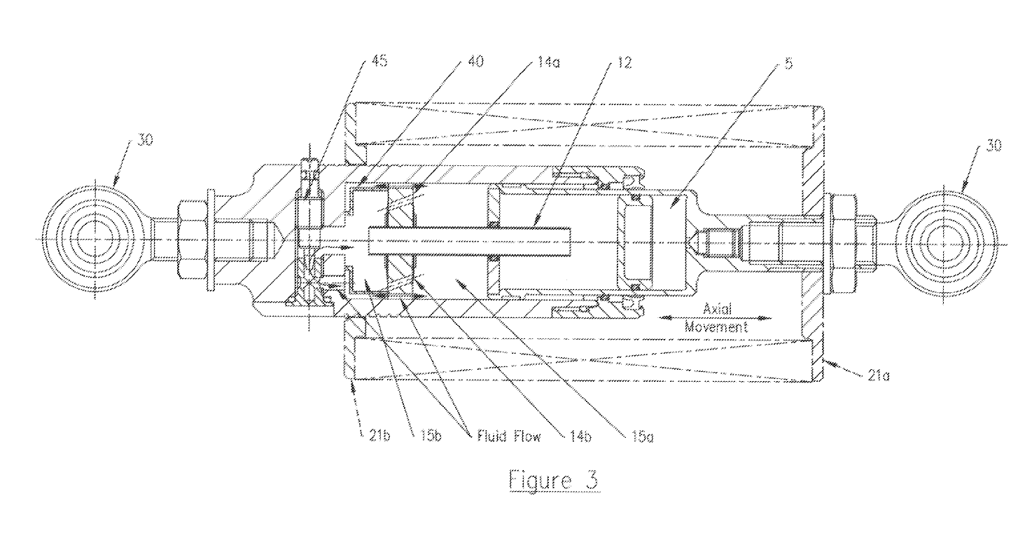

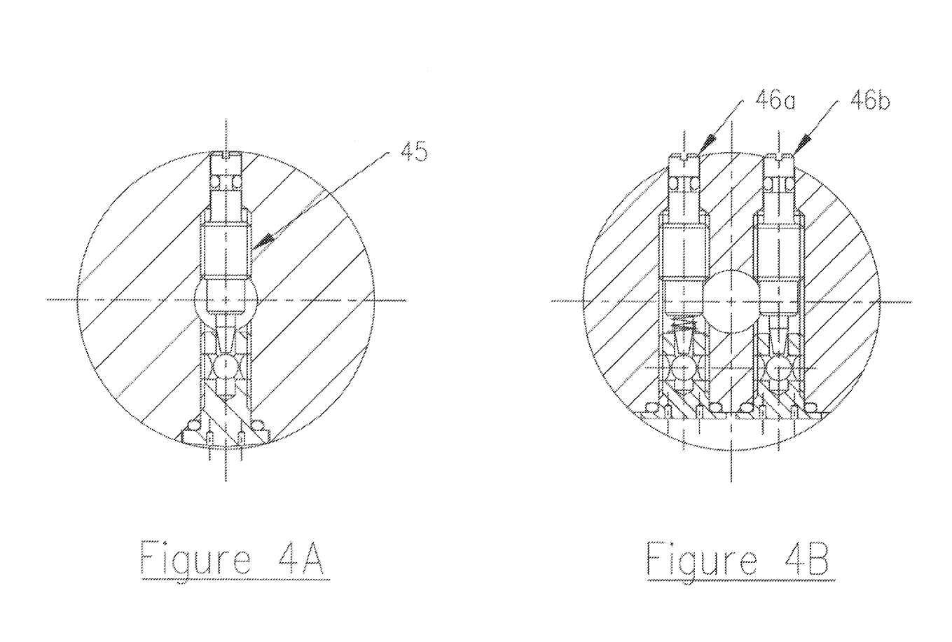

FIG. 3 shows a further embodiment which depicts the incorporation of a means of allowing damping fluid to by-pass the damping valve assembly and further enabling this by-passed fluid's flow rate to be adjustable. The adjustment can be single, to provide the same flow rate during extension and retraction (as illustrated in FIGS. 3 and 4a), or dual, allowing independent flowrate adjustment for extension and for retraction (as illustrated in FIG. 4b). In FIG. 3, like reference numerals are used to show like features. The damper comprises a damper valve arrangement which is provided with a bypass channel 40 which is provided at the circumference of the damping valve 14, and directly communicates with the sub-chamber 15a. The bypass channel communicates with a flow rate adjuster 45. The adjuster comprises a constriction which can be manually controlled to adjust the rate of fluid flow therethrough. An opposite side of the adjuster communicates with the sub-chamber 15b. A needle-valve of the adjuster can be translated in order to control the size of the constriction.

The damper fluid by-passing the damper valve assembly can be achieved by inserts, grooves, slots or holes on the damping valve assembly or on the oil cylinder or both to enable damping fluid to flow independently to the damper fluid by-pass adjuster(s) and into the tube. The damping fluid adjustment can be achieved by using any regulating valve e.g. a needle valve, butterfly valve, pressure differential valve, etc. It is noted non-return valves are required for each adjuster of the dual option to enable one adjuster to receive damper fluid flow during extension and the other during retraction.

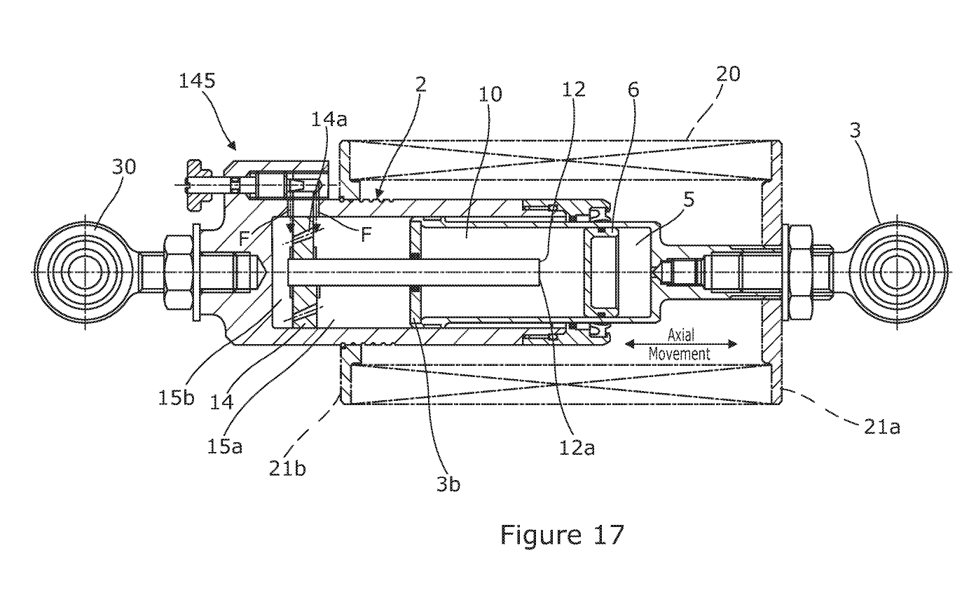

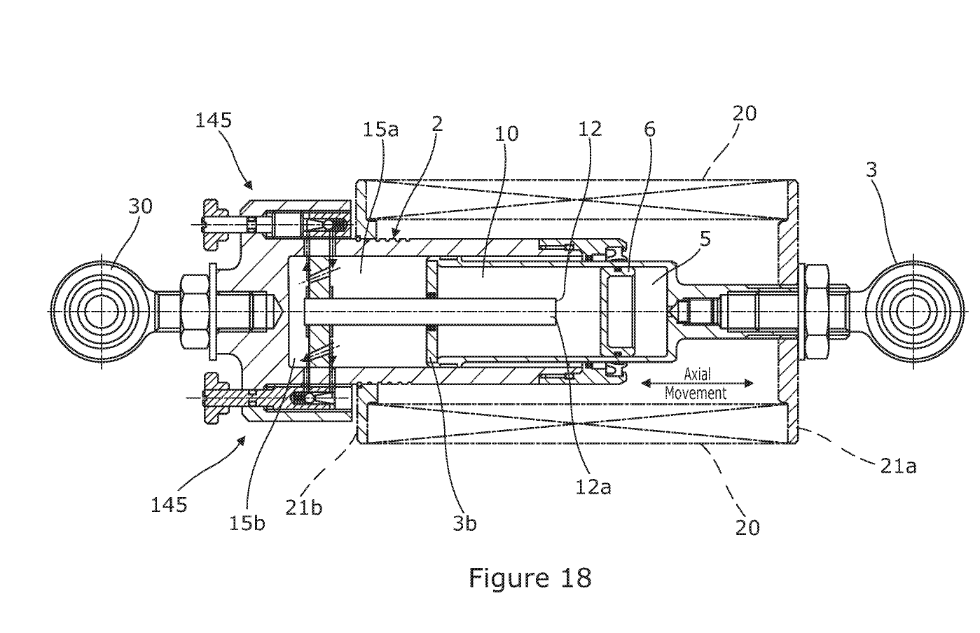

Reference is made to FIGS. 17 and 18 which show modified versions of the embodiment of FIG. 3 in which include single and dual damping valve bypass adjusters, respectively. In particular, each of those embodiments provides an alternative location to incorporation within the oil cylinder cap, as shown in the embodiment of FIG. 3. In FIG. 17, a side wall of the cylinder 2 is provided with two bores, denoted F, provided on respective sides of the separator 14, and communicates with respective spaces 15a and 15b. Secured to the outer of the cylinder there is provided a flow rate adjuster 145—which is similar in construction and functionality to the adjuster 45. The adjuster 145 comprises a manually—controllable constriction which allows the rate of fluid-flow therethough to be adjusted, and moreover fluid from/to each of the sub-chambers 15a and 15b, by way of selected manual setting. This in turn affects the performance characteristics of the damper. In FIG. 18, an adjuster 145 is shown on diametrically opposed sides of the chamber.

In FIG. 4a, the flow adjuster 45 comprising a single needle valve is shown in which bi-directional flow rate can be regulated, whereas in FIG. 4b an adjuster comprising two needle valves is shown in which (uni-directional) flow rate can be set for each direction of damping fluid flow.

Having the ability to meter damping fluid by-passing the damping valve arrangement enables the damping forces generated within the damper to be variable. As the adjusters are required to meter the damper fluid flow rate between the cylinder and the tube, the adjusters are ideally located within the top of the cylinder.

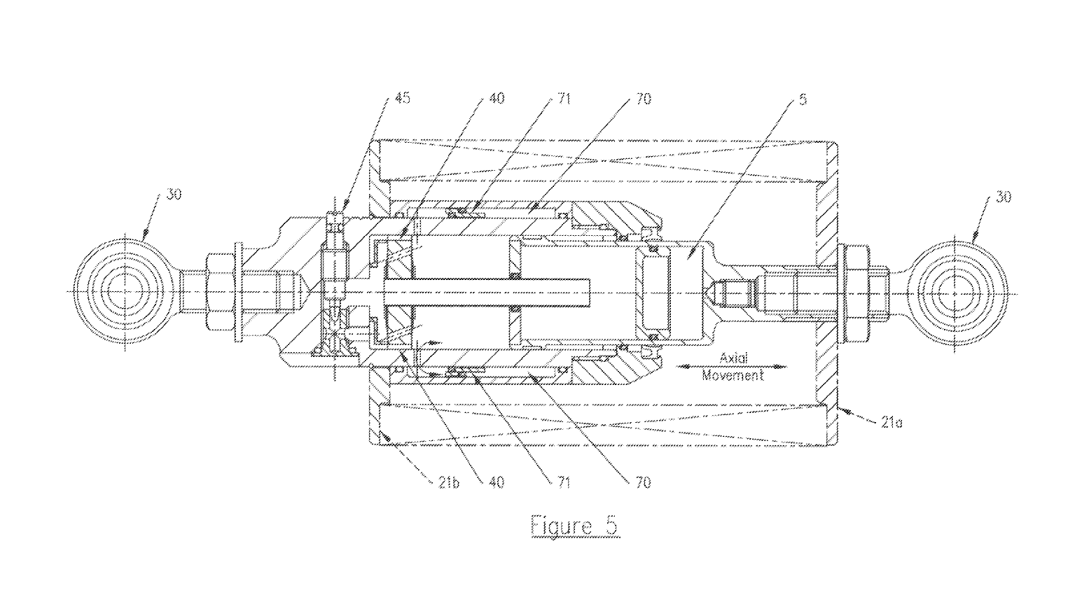

Reference is now made to FIG. 5 which additionally comprises an external gas chamber 70 incorporated concentrically outside the oil cylinder. This external gas chamber includes a piston and seal arrangement 71 to separate the damping fluid from the gas. (Note: a charged bladder can also be used to charge the external gas chamber instead of the piston and seal arrangement.)

The cylinder is provided with ports allowing damping fluid to flow between the cylinder and (a sub-chamber of) the external gas chamber. Although the ports are illustrated on one side of the damping value arrangement, they can be positioned either side. However, locating to the same side as gas chamber 5 is preferred as the damping fluid is at its highest pressure during retraction, and not the other side where the pressure is lower due to the pressure drop caused by the damp fluid flowing through the damping valve assembly.

In use, the retraction of the damper causes the damping fluid to compress the gas in gas chamber 5 which increases its pressure and thus increase the pressure of the damping fluid, causing a pressure drop across the damping valve arrangement which allows conveyance of damping fluid through the damping valve arrangement and through any damper valve adjustment and into the tube.

In application, the external gas chamber 70 working in conjunction with gas chamber 5 can be used to reduce the volume of gas chamber 5 so the combined volume remains the same and allows the piston rod to be shortened, thus compacting the damper design.

The external gas chamber is used in conjunction with gas chamber 5 to achieve the following:
a) If the charge pressures are the same, the combined areas reduces the rate of rise in pressure within the gas spring when the damper retracts to become more linear. As the damper retracts both gas pistons compress the gas at the same time.
b) If the charge pressures are different, it produces two different gas springs. The lower pressure being the softer gas spring followed by the higher pressure being the harder gas spring. As the damper retracts the lower charged piston retracts first followed by the higher charged piston.
c) If the gas piston working areas are different, it produces a rising rate spring comprising of the two gas spring curves. As the damper retracts the large working area piston moves until the raised pressure enables the smaller working area piston to move until the raised pressure allows the larger working area piston to move, and so repeating the cycle.
d) If the gas piston working volumes are different, it produces a rising rate spring comprising of the two gas spring curves. As the damper retracts the two gas pistons move together until the movement of the lower working volume piston increases the pressure stopping it from moving, allowing the larger volume piston to continue to move until the raised pressure allows the lower working volume piston to move, and so repeating the cycle.

In application, it will be appreciated that a damper can have a combination of all of the above, i.e. the different gas chambers can have different charge pressures, working areas and working volumes.

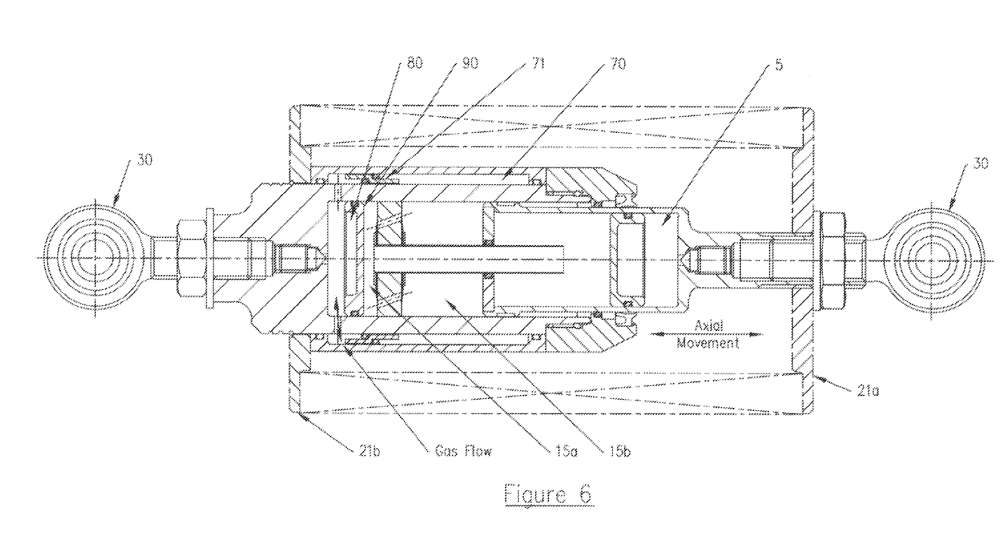

FIG. 6 illustrates a damper embodiment which comprises three gas chambers, namely including a further gas chamber 80. The independent chamber 5 located within the con rod, and two interconnected chambers 70 and 80 are located inside and outside the cylinder space, separated by the separator 71. The damping fluid sub-chamber 15a is separated from the gas chamber 80 by a divider 90. All three gas chambers can either be charged at the same pressure or independently charged at different pressures.

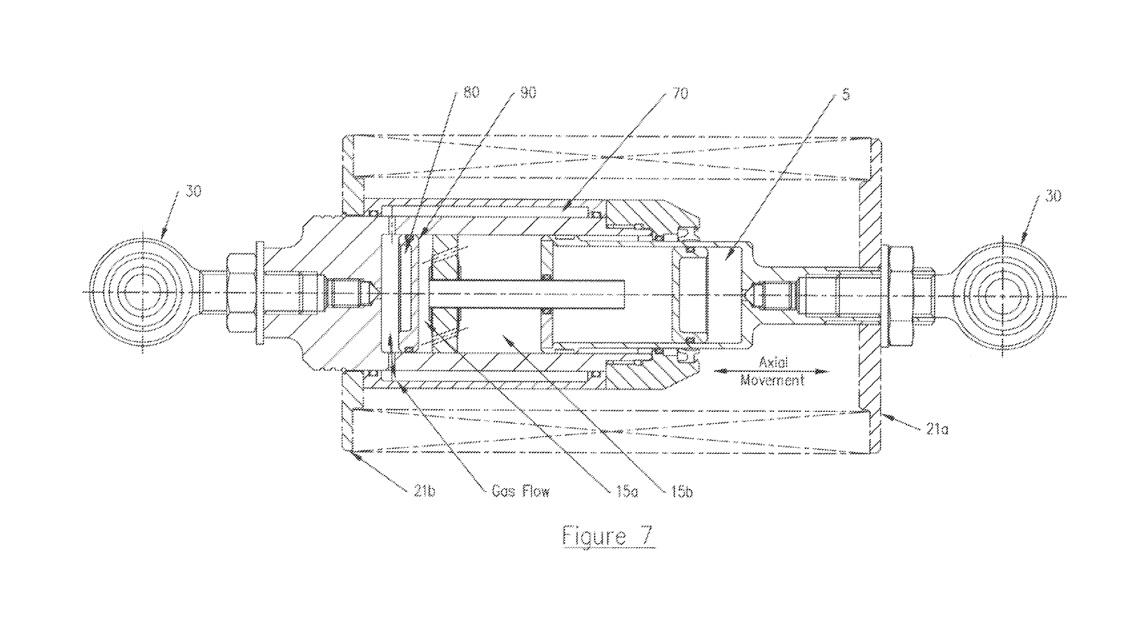

FIG. 7 illustrates a damper embodiment which comprises two gas chambers, including gas chamber 80. The independent chamber 5 located within the con rod, and two interconnected chambers 70 and 80 are located inside and outside the cylinder space. The damping fluid sub-chamber 15a is separated from the gas chamber 80 by a divider 90. Both gas chambers can either be charged at the same pressure or independently charged at different pressures.

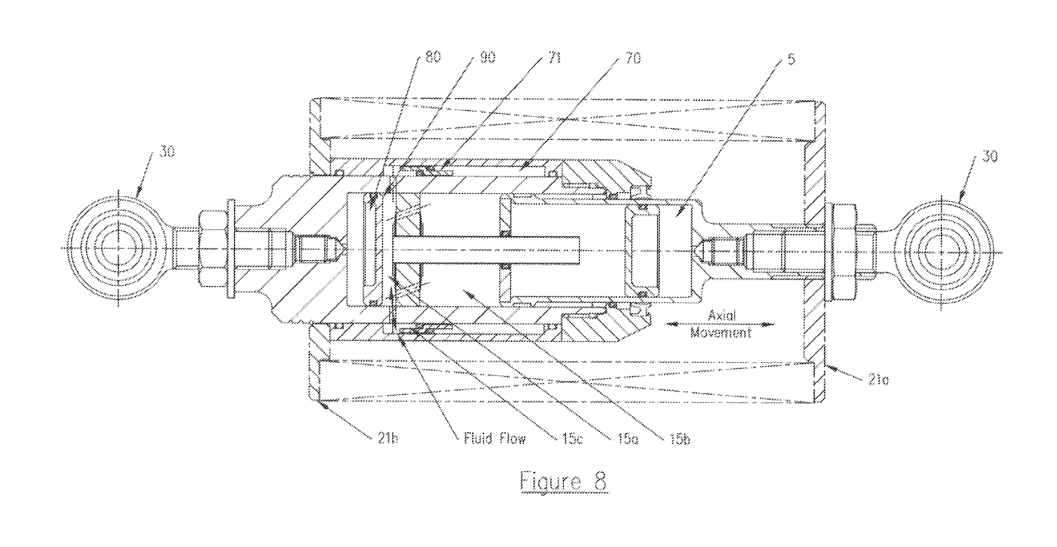

FIG. 8 illustrates a damper embodiment which comprises three independent gas chambers. The independent chamber 5 located within the con rod, and two independent chambers 70 and 80 are located inside and outside the cylinder space. The damping fluid sub-chamber 15a is separated from the gas chamber 80 by a divider 90, and the damping fluid sub-chamber 15c is separated from the gas chamber 70 by a divider 71.

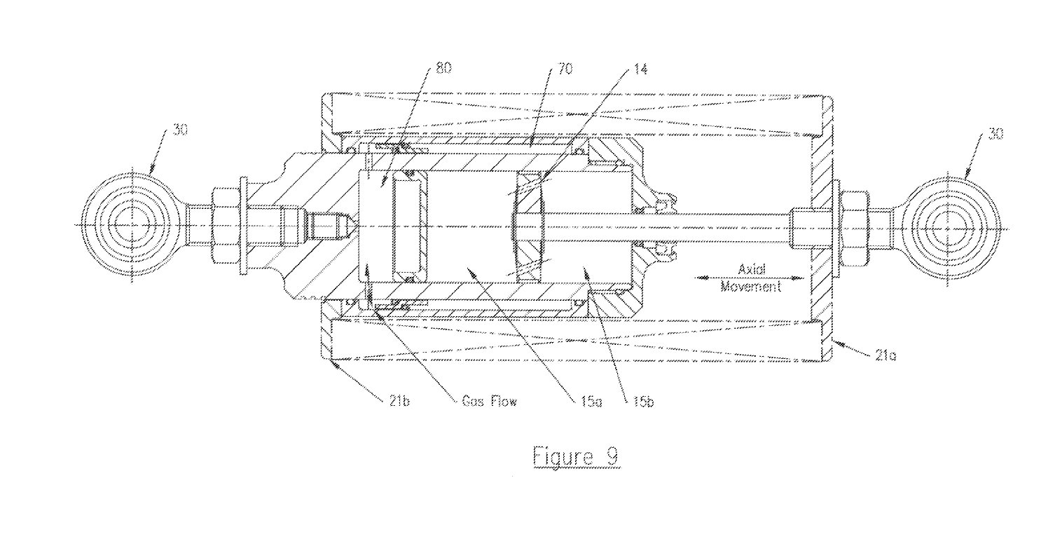

FIG. 9 illustrates a damper having a gas chamber located within the cylinder combined with an auxiliary external gas chamber, allowing the damper to be compact in length. The damping fluid sub-chamber 15a is separated from the gas chamber 80 by a divider 90, and the damping fluid sub-chamber 15c is separated from the gas chamber 70 by a divider 71. Both gas chambers can either be charged at the same pressure or independently charged at different pressures. It is noted the solid internal gas piston can be replace by a bladder or a flexible diaphragm.

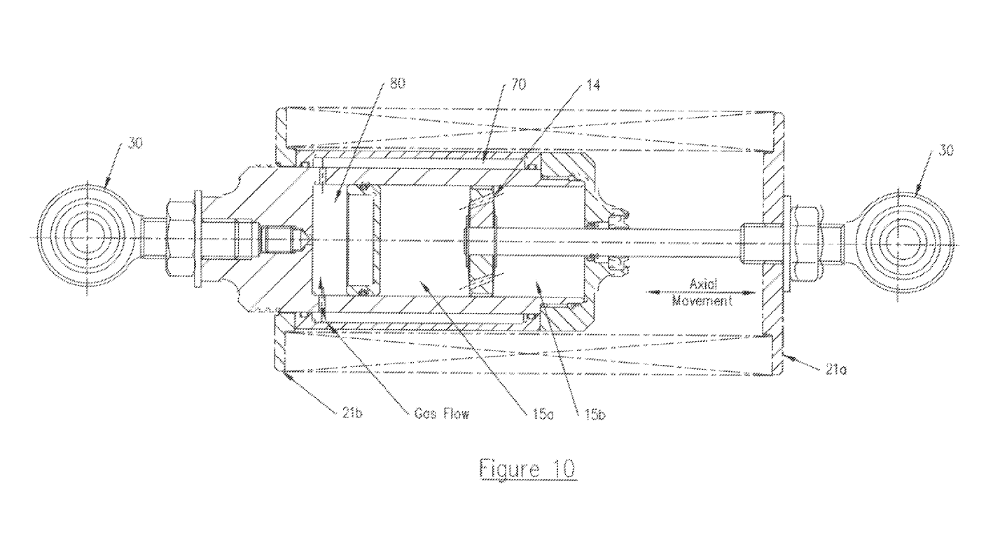

FIG. 10 illustrates a damper having a gas chamber located within the cylinder combined with an auxiliary external gas chamber, allowing the damper to be compact in length. It is noted the solid internal gas piston can be replace by a bladder or a flexible diaphragm. The damping fluid sub-chamber 15a is separated from the gas chamber 80 by a divider 90.

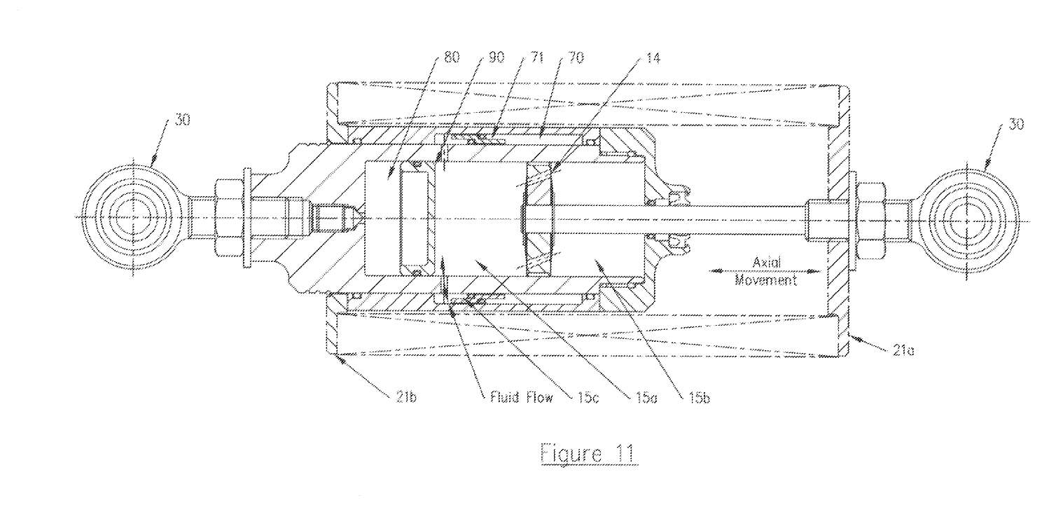

FIG. 11 illustrates a damper having a gas chamber located within the cylinder combined with an auxiliary external gas chamber, allowing the damper to be compact in length. The damping fluid sub-chamber 15a is separated from the gas chamber 80 by a divider 90, and the damping fluid sub-chamber 15c is separated from the gas chamber 70 by a divider 71. Both gas chambers can either be charged at the same pressure or independently charged at different pressures. It is noted the solid internal gas piston can be replace by a bladder or a flexible diaphragm.

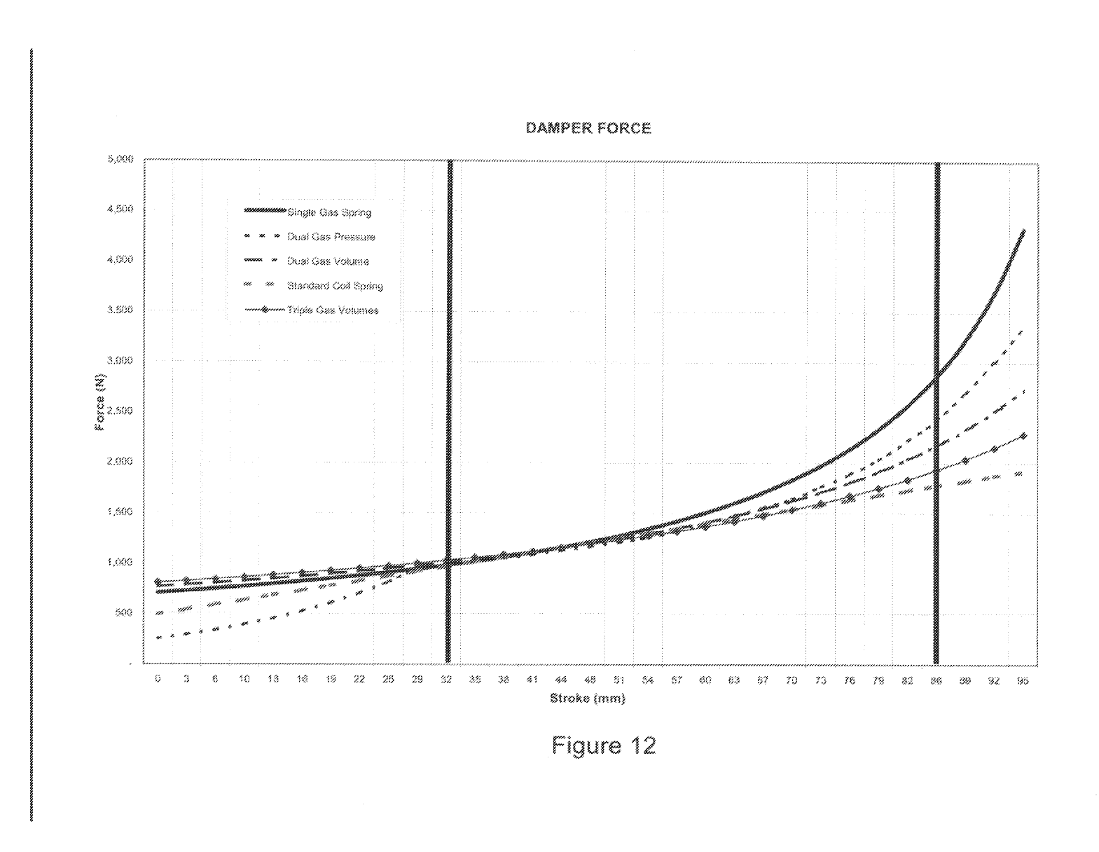

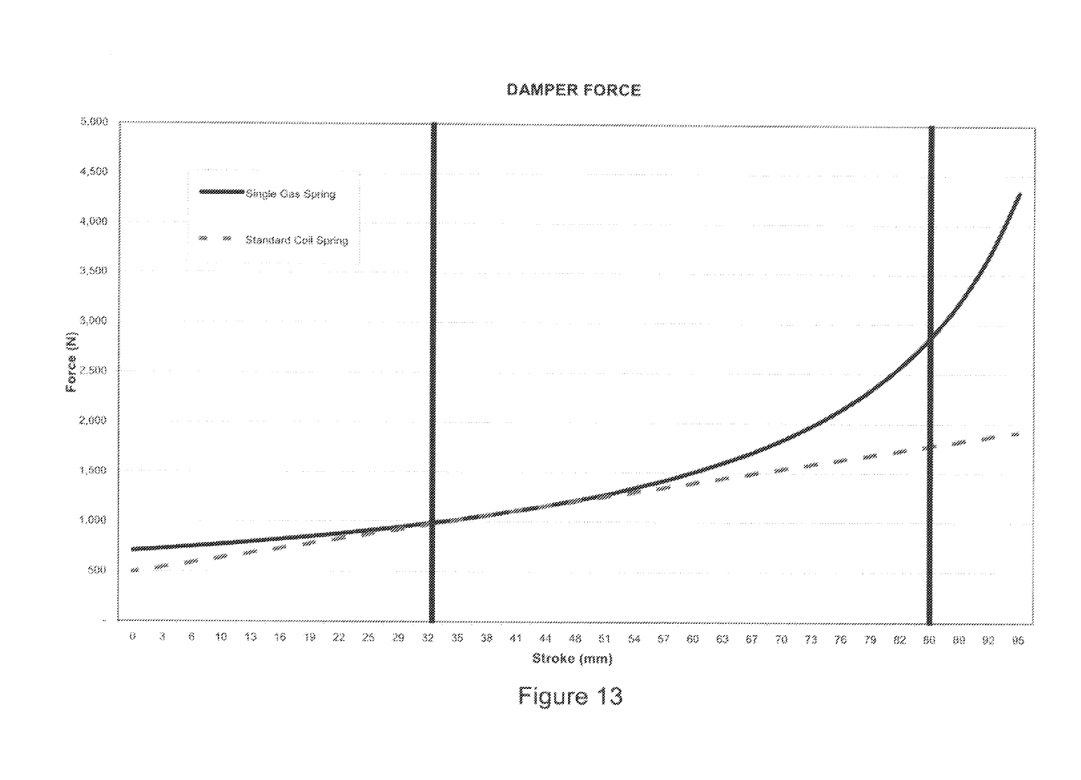

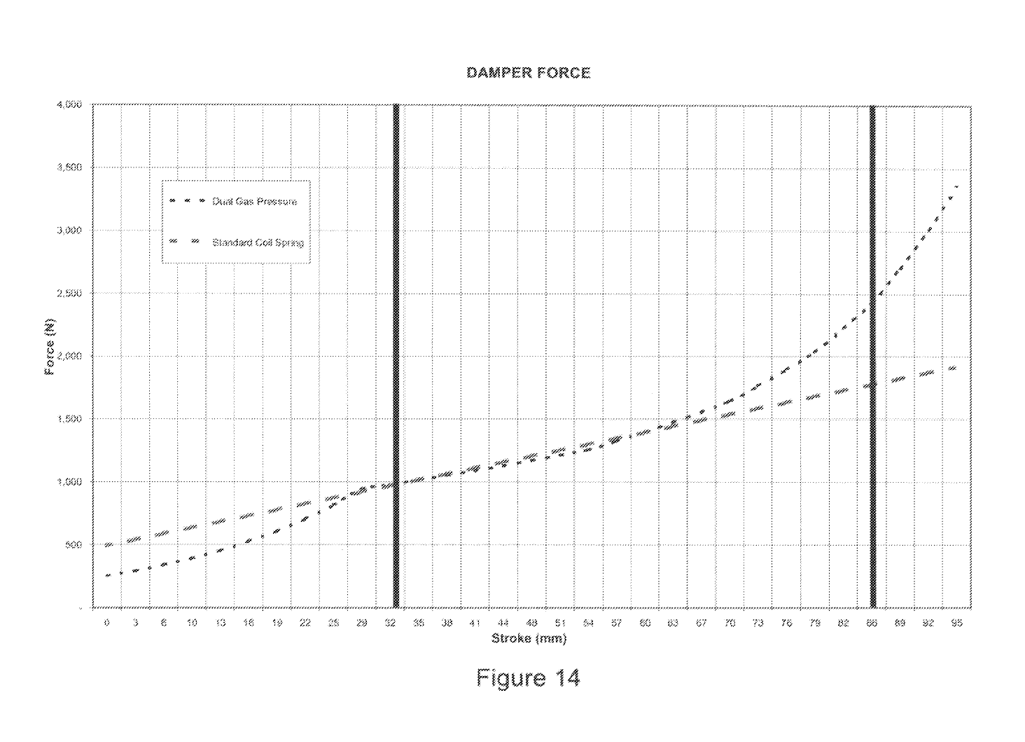

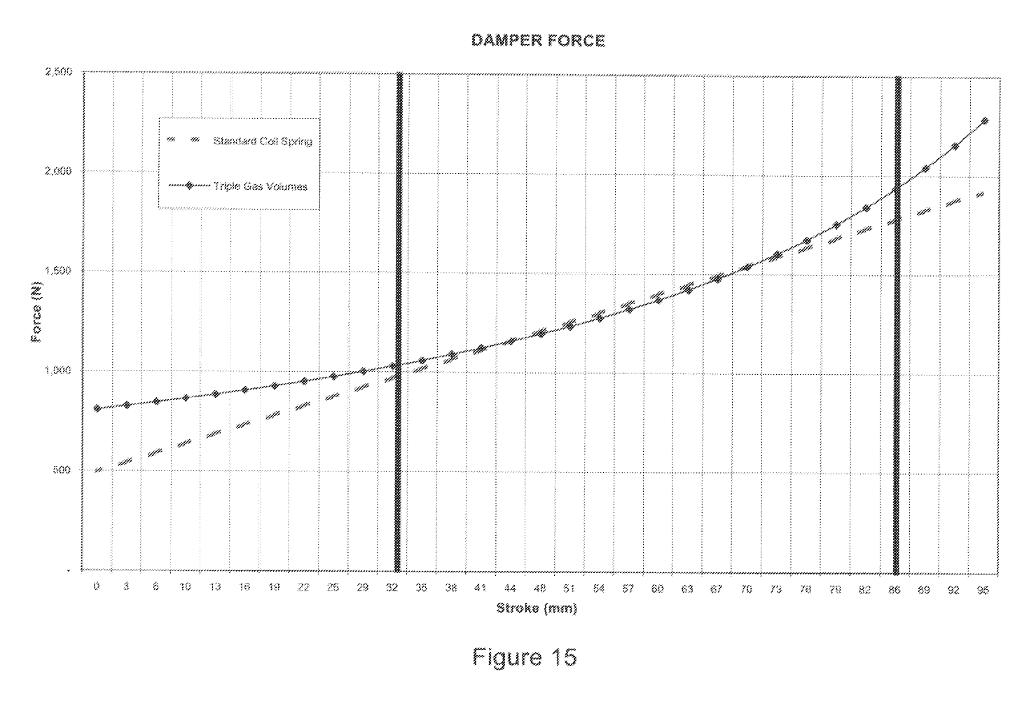

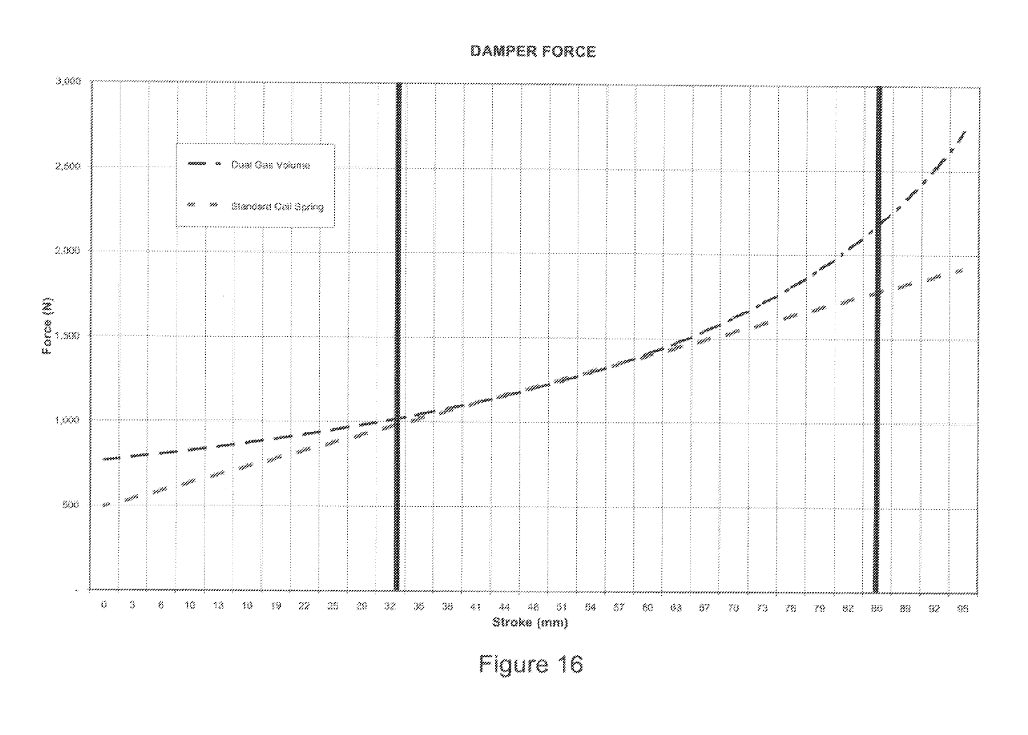

FIGS. 12 to 16 show various force to stroke (length) to indicate the different spring characteristics of different damper types.

1. A shock absorber damper comprising a cylinder housing and a piston, the piston comprising a piston damping fluid sub-chamber and a gas sub-chamber, said sub-chambers separated by a moveable divider, the damper further comprising a tube which allows displacement of damping fluid therethrough, the tube comprising a first port and a second port which are spaced apart from each other along the length of the tube, the damper further comprising a damper valve provided between a first sub-chamber and a second sub-chamber, wherein the tube is configured to allow flow of fluid between one of the sub-chambers and the piston damping fluid chamber.

2. The damper of claim 1 in which the tube is arranged to allow displacement of damping fluid between damping fluid chambers.

3. The damper of claim 1 in which the piston comprises an aperture through which the tube is arranged to be received.

4. The damper of claim 1 in which the damper comprises a seal which seals the tube within the aperture, whilst allowing relative movement between the tube and the piston.

5. The damper of claim 1 in which the damper valve comprises two uni-directional valve assemblies, each of which allows fluid flow in a respective direction opposite to the direction of flow of the other.

6. A damper as claimed in claim 1 in which the piston is arranged to receive the tube such that the piston is arranged for reciprocal relative movement to the tube.

7. A damper as claimed in claim 1 in which the tube is fixed to the damper valve assembly.

8. A damper as claimed in claim 1, in which the tube is fixedly attached to the piston and slidably mounted by the damper valve.

9. A damper as claimed in claim 1 in which the damper comprises a piston damping fluid chamber and a cylinder space damping fluid chamber, which cylinder space chamber comprises the first and second sub-chambers.

10. A damper as claimed in claim 1 in which the tube is arranged to allow movement of damping fluid between the piston damping fluid chamber and the cylinder space damping fluid chamber.

11. A damper as claimed in claim 1 in which the tube comprises an open distal end which is arranged to be located within or in communication with the piston damping fluid chamber.

12. A damper as claimed in claim 1 in which the tube is provided in a fixed position relationship relative to the cylinder space.

13. A damper as claimed in claim 1 in which the piston damping fluid chamber is provided as a space within the piston.

14. A damper as claimed in claim 1 in which a first working surface area of the piston presented to and acting on damping fluid in a sub-chamber is substantially the same as a second working surface area presented to fluid in the piston chamber by a surface in the piston chamber which faces in the direction of a compression movement.

15. A damper as claimed in claim 1 in which a damping fluid flow rate through the damping valve is substantially the same during extension and retraction, namely in both directions of flow of the damping fluid.

16. A damper as claimed in claim 1 in which one of the sub-chambers is arranged adjacent to the working surface of the piston.

17. A damper as claimed in claim 14 in which the first working surface area is a forward facing end surface of the piston.

18. A damper as claimed in claim 1 in which the moveable divider arranged to translate relative to the sub-chambers in response to pressure differential between said sub-chambers.

19. A damper as claimed in claim 1 in which the gas sub-chamber and the piston damping fluid sub-chamber are located within a piston chamber space.

20. A damper as claimed in claim 1 in which the tube is fixedly attached to the piston and movable relative to the damper valve.

21. A damper as claimed in claim 1 in which the damper valve is fixedly secured to a cylinder wall.

22. A damper as claimed in claim 1 which comprises a bypass channel to allow fluid to bypass the damper valve, and a fluid flow adjuster in communication with the channel to adjust the rate of flow passing from one sub-chamber to the other via the adjuster.

23. A damper as claimed in claim 22 in which the bypass channel comprises a through-hole which is provided in the damper valve.

24. A damper as claimed in claim 1 which comprises a fluid flow adjuster which is provided adjacent to a distal end of the chamber.

25. A damper as claimed in claim 24 which comprises a bi-directional fluid flow adjuster which provides a single adjustment of the damping fluid flow rate being substantially the same during extension and retraction, namely in both directions of flow of the damping fluid.

26. A damper as claimed in claim 24 which comprises two uni-directional fluid flow adjusters, each arranged to independently control fluid flow in opposite directions of flow of the damping fluid.

27. A damper as claimed in claim 1 which comprises a gas chamber which is fixedly located to a side of the cylinder housing, and arranged to provide a spring force to reciprocation of the piston.

28. A damper as claimed in claim 27 in which the gas chamber comprises an annular space extending around the cylinder housing.

29. A damper as claimed in claim 27 in which the gas chamber is at least in part of substantially cylindrical annulus form.

30. A damper as claimed in claim 27 which a piston is provided in the gas chamber and moveable within the gas chamber, and sealed with the chamber so as to partition gas on one side and damping fluid on an opposite side.

31. A shock absorber damper comprising a cylinder housing and a piston, the cylinder housing defining an inner cylinder space in which the piston is arranged to reciprocate, and wherein a gas chamber is provided at an outer portion of the cylinder housing and integral with the cylinder housing, and gas in the gas chamber arranged to communicate with a sub-chamber provided in the cylinder space to provide damping to the piston.

32. An absorber as claimed in claim 31 in which the cylinder housing comprises a part to allow the communication of the gas.

33. (canceled)
